(19) United States
(12) Patent Application Publication
(10) Pub. No.: US 2011/0007201 A1
(43) Pub. Date: Jan. 13, 2011

(54) SOLID STATE IMAGING DEVICE SUPPRESSING BLOOMING

(76) Inventor: You YOSHIOKA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/832,382

(22) Filed: Jul. 8, 2010

(30) Foreign Application Priority Data
Jul. 9, 2009 (JP) 2009-162929

(51) Int. Cl. H04N 5/225

(52) U.S. Cl. 348/340; 348/E05.024

(57) ABSTRACT

According to one embodiment, a solid state imaging device includes a pixel unit, a conversion circuit, and a mode selection circuit. The pixel unit includes pixels. The pixels include a photoelectric conversion element, a read circuit, an amplification circuit, and a reset circuit. The photoelectric conversion element converts light including white and having passed through optical color filters, into electric signal. The conversion circuit converts the signal charge output from the pixels, into a digital signal. The mode selection circuit selects one of the two modes, based on a level of the signal charge. A first mode is to uses the signal charge from the pixel with the white optical color filter. A second mode is to avoid using the signal charge from the pixel with the white optical color filter.

### CROSS-REFERENCE TO RELATED APPLICATIONS

This application is based upon and claims the benefit of priority from Japanese Patent Application No. 2009-162929, filed Jul. 9, 2009; the entire contents of which are incorporated herein by reference.

### FIELD

Embodiments described herein relates generally to a complementary metal oxide semiconductor (CMOS) image sensor used for a cellular phone with a camera, a digital camera, or a video camera.

### BACKGROUND

For CMOS image sensors, various methods for increasing a dynamic range for high-light-level image taking have been proposed. The CMOS image sensors have determined whether or not white data is likely to be saturated on a high-illuminance (high-light-intensity) side, and if the white data is not likely to be saturated on the high-illuminance side, using a W (white) pixel signal value directly as the white data. This enables the acquisition of images that are excellent in reproduction of color information with low illuminance (low-light-intensity).

According to the conventional proposals such as Jpn. Pat. Appln. KOKAI Publication No. 2008-22521, W pixels are used to increase the dynamic range of CMOS image sensors. For low-light-intensity image taking, these methods serve to increase a signal-to-noise ratio based on the high sensitivity of the W pixel. However, for high-light-intensity image taking, the sensitivity of the W pixel is excessively high, resulting in the likelihood of saturation and thus blooming of red-green-blue (RGB) pixels.

### BRIEF DESCRIPTION OF THE DRAWINGS

FIG. 1 is a block diagram showing an example of the configuration of an image sensor (amplifying CMOS image sensor) according to an embodiment;

FIG. 2 is a diagram specifically showing a part of the amplifying CMOS image sensor shown in FIG. 1;

FIG. 3 is a diagram of the configuration of the amplifying CMOS image sensor shown in FIG. 1, the diagram showing an example of arrangement of optical color filters in an image area of a pixel unit;

FIG. 4 is a signal waveform diagram illustrating operational timings taking a VGA sensor as an example; and

FIG. 5 is a signal waveform diagram illustrating operational timings taking the VGA sensor as an example.

### DETAILED DESCRIPTION

In general, according to one embodiment, an solid state imaging device includes a pixel unit, a conversion circuit, and a mode selection circuit. The pixel unit includes a plurality of pixels which are two-dimensionally arranged on a semiconductor substrate. Each of the plurality of pixels includes a photoelectric conversion element, a read circuit, an amplification circuit, and a reset circuit. The photoelectric conversion element converts light including white and having passed through optical color filters, into electric signal. The read circuit reads signal charges obtained by the photoelectric conversion element, into the detector. The amplification circuit amplifies the signal charges read into the detector. The reset circuit removes unwanted signal charges from the detector. The conversion circuit converts the signal charge output from each of the plurality of pixels, into a digital signal. The mode selection circuit which, if a level of the signal charge as the digital signal is below a saturation level, selects a first mode which uses the signal charge from the pixel with the white optical color filter, and the mode selection circuit which, if the level of the signal charge reaches the saturation level, selects a second mode which avoids using the signal charge from the pixel with the white optical color filter.

An embodiment will be described below with reference to the drawings. In connection with the description, common components are denoted by the respective common reference numbers throughout the drawings.

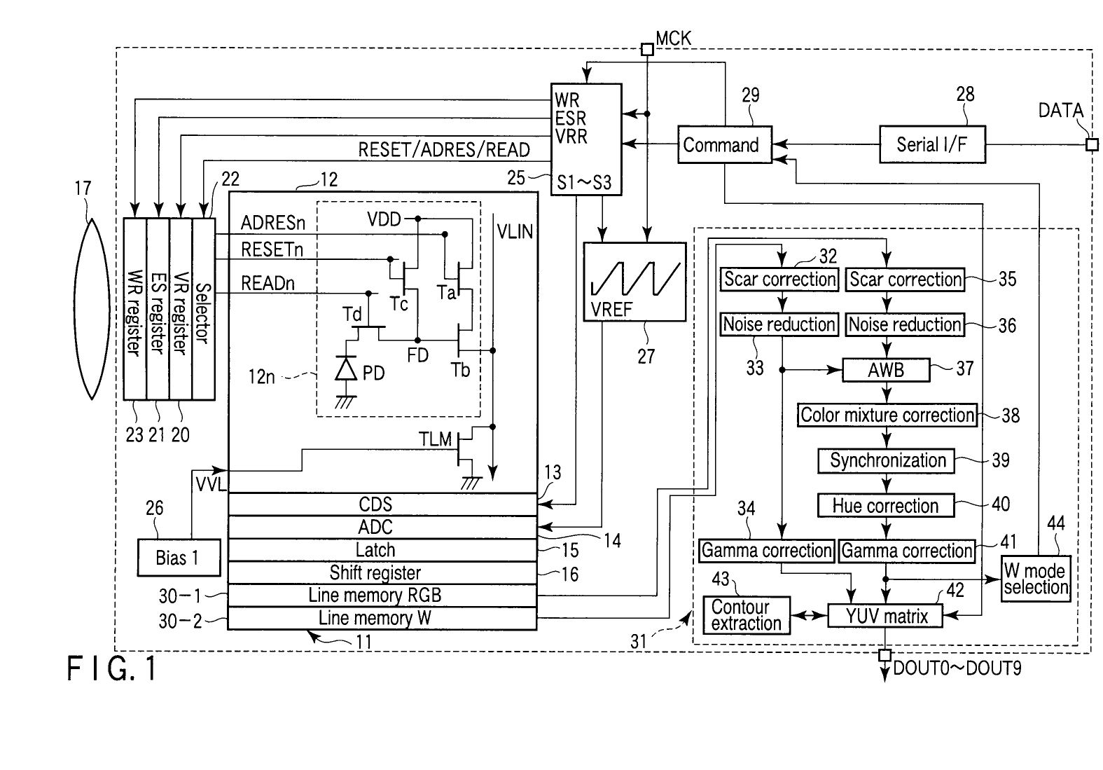

FIG. 1 shows the basic configuration of an image sensor according to the present embodiment. By way of example, an image sensor in the present embodiment is an amplifying CMOS type.

As shown in FIG. 1, the following components are arranged in a sensor core unit 11: a pixel unit 12, a columnar noise cancellation circuit (CDS) 13, a columnar analog-to-digital converter (ADC) 14, a latch circuit 15, and a horizontal shift register 16. The pixel unit includes a plurality of cells 12n (FIG. 1 shows only one cell). This will be described below. The cell 12n includes a photodiode PD as a photoelectric conversion element. Light is incident on the pixel unit 12 of the cell 12n via a lens 17 and an optical color filter (not shown in the drawings). Charges are generated by photoelectric conversion in accordance with the intensity of incident light and accumulated in the photodiode PD.

The signal charges (analog signals) generated by photoelectric conversion are supplied to ADC 14 via CDS 13. The signal charges as analog signals are converted into digital signals by ADC 14. The digital signals are then latched by the latch circuit 15. The digital signals latched by the latch circuit 15 are sequentially transferred and read by the horizontal shift register 16.

Furthermore, the following components are arranged adjacent to the pixel unit 12: a vertical register (VR register) 20 configured to allow signals to be read, a vertical register (ES register) 21 configured to allow an accumulation time to be controlled, a pulse elector circuit (selector) 22, and a vertical register (WR register) 23 configured to allow white pixels to be reset and controlled.

Read of signals from the pixel unit 12 and control of CDS 13 are performed by pulse signals S1 to S3, ESR, VRR, RESET ADRES, READ, and WR output by a timing generator (TG) 25. The pulse signals S1 to S3 are supplied to CDS 13. The pulse signal ESR is supplied to the ES register 21. The pulse signal VRR is supplied to the VR register 20.

The pulse signals RESET, ADRES, and READ are supplied to a pulse selector circuit 22.

The pulse signal WR is supplied to the WR register 23.

The register 20 and 21 select any of the vertical lines in the pixel unit 12. The pulse signals RESET, ADRES, and READ are supplied to the pixel unit 12 via the pulse selector circuit 22. A bias voltage VVL from a bias generation circuit (bias 1) 26 is applied to the pixel unit 12.

The VREF generation circuit 27 operates in response to a main clock signal to generate a reference waveform (for example, a triangular wave VREF) for analog-to-digital conversion. The amplitude of the reference waveform is controlled based on data input to a serial interface 28.

A command input to the serial interface 28 is supplied to a command decoder 29, which then decodes the command. The decoded command is supplied to the timing generator 25 together with a main clock signal MCK.

The VREF generation circuit 27 generates and supplies a triangular wave VREF to ADC 14 in order to allow one analog-to-digital conversion to be performed during one horizontal scan period.

When the digital signals output by the latch circuit 15 are from a red pixel, a green pixel, and a blue pixel, the signals are input to a line memory (RGB) 30-1.

When the digital signal is from a white pixel, the signal is input to a line memory (W) 30-2.

The main processor 31 includes a scar correction circuit 32, a noise reduction circuit 33, a gamma correction circuit 34, a scar correction circuit 35, a noise reduction circuit 36, an automatic white balance (AWB) circuit 37, a color mixture correction circuit 38, a synchronization circuit 39, a hue correction circuit 40, a gamma correction circuit 41, a YUV matrix circuit 42, a contour extraction circuit 43, and a W mode selection circuit 44.

The scar correction circuit 35 estimates and compensates for element defect areas using values for peripheral pixels while reading signals from the line memory (RGB) 30-1. The scar correction circuit 35 then transmits the signals to the noise reduction circuit 36.

The noise reduction circuit 36 removes noise from flat portions and transmits the resultant signals to the AWB circuit 37.

AWB 37 determines which portions of a screen are expected to be white. Thereafter, AWB 37 multiples a red pixel signal, a green pixel signal, and a blue pixel signal by the respective gains to change the balance among the signals so that the portions of the screen (one frame) expected to be white have a preferable image in an output image. AWB 37 then transmits the resultant signals to the color mixture correction circuit 38.

The color mixture correction circuit 38 uses a fixed-rate subtraction to remove, for example, wavelength separation in the optical color filter, spill-over of a light flux into adjacent pixels, or mixture of signals from the respective signals caused by electric interference. Thereafter, the color mixture correction circuit 38 transmits the values resulting from the fixed-rate subtraction to the gamma correction circuit 41 via the synchronization circuit 39 and the hue correction circuit 40.

The gamma correction circuit 41 applies a predetermined signal gamma curve to an image output format. The gamma correction circuit 41 then transmits the resultant signals to the YUV matrix circuit 42.

On the other hand, the scar correction circuit 32 estimates and compensates for element defect areas using values for peripheral pixels while reading signals from the line memory (RGB) 30-2. The scar correction circuit 32 then reads the signals resulting from the read and compensation, from the line memory (W) 30-2. The scar correction circuit 32 transmits the resultant signals to the noise reduction circuit 33.

The noise reduction circuit 33 removes noise from flat portions and transmits the resultant signals to the gamma correction circuit 34 and the automatic white balance circuit 37.

The gamma correction circuit 34 applies a predetermined signal gamma curve to an image output format. The gamma correction circuit 34 then transmits the resultant signals to the YUV matrix circuit 42.

The YUV matrix circuit 42 generates a color difference signal YUV (Y signal) based on the white, red, green, and blue pixel signals. The YUV matrix circuit 42 outputs the color signal YUV (Y signal) to an external device as image information DOUT0 to DOUT9. In this case, the YUV matrix circuit 42 transmits the signals to the contour extraction circuit 43 to extract the contour of the picture. Then, the extracted values are returned to the YUV matrix circuit 42, which then improves the color edge of the contour.

The W mode selection circuit 44 checks the red, green, and blue pixel signals output by the gamma correction circuit 41 for intensity (total value). The W mode selection circuit 44 then determines from the total value whether or not photoelectrons (signal charges) from the white pixel are close to a saturation level. Depending on whether the level of photoelectrons is at most or at least the saturated one, the W mode selection circuit 44 outputs an appropriate W mode selection signal to the command decoder 29.

Here, as a signal source, the W mode selection circuit uses the signals resulting from the gamma correction (output from the gamma correction circuit 41) because the signals are easy to obtain. However, when signals not having undergone color adjustment such as white balance are used to predict possible saturation of the W pixels, relevant functions are simplified, and relevant accuracy is stabilized. Thus, the signals input to the main processor 31 may be input to the W mode selection circuit 44.

Furthermore, the command decoder 29 outputs, to the timing generator 25 and the YUV matrix circuit 42, an instruction for switching between a mode which uses the white pixel signal for signal generation (image) and a mode which avoids using the white pixel signal for signal generation.

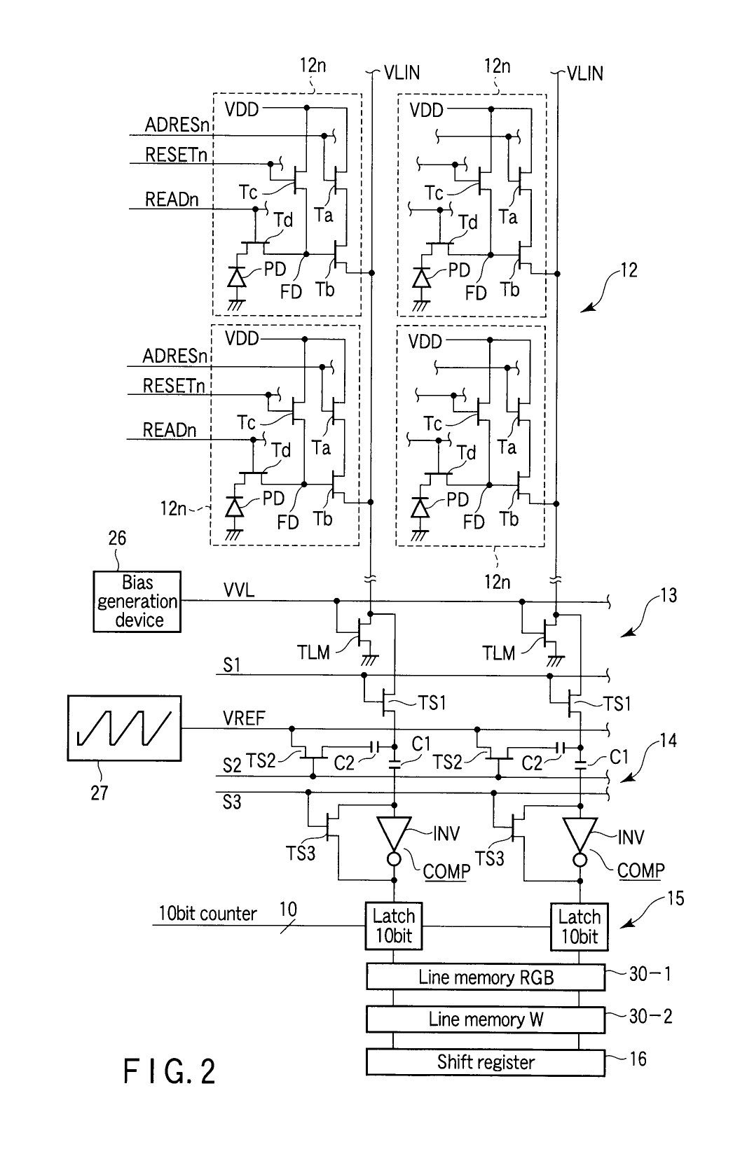

FIG. 2 shows an example of the configuration of the pixel unit 12, CDS 13, and ADC 14 in the amplifying CMOS image sensor shown in FIG. 1.

In the pixel unit 12, a plurality of cells (pixels) 12n are two-dimensionally arranged in rows and columns, in other words, the cells 12n are arranged in a matrix. Each of the cells 12n includes a row selection transistor Ta, an amplifying transistor Tb, a reset transistor Tc, a read transistor Td, and a photodiode (photoelectric conversion element) PD.

In each of the cells 12n, current paths in transistors Ta and Tb are connected between and in series with a power source VDD and a vertical signal line VLIN. A pulse signal ADRESn from the pulse elector circuit 22 is supplied to a gate of transistor Ta.

In transistor Tc, a voltage VDD is supplied to one end of the current path. The other end of the current path is connected a gate (detector FD) of transistor Tb. A pulse signal RESETn from the pulse selector circuit 22 is supplied to a gate of transistor Tc.

Furthermore, in transistor Td, one end of the current path is connected to the detector FD. A pulse signal (read pulse) READn from the pulse selector circuit 22 is supplied to the gate. A cathode of the photodiode PD is connected to the other end of the current path in transistor Td. An anode of the photodiode PD is grounded.

The other ends of transistors Tb included in the cells 12n in each column are all connected to the vertical signal line VLIN.

Each of the vertical signal lines VLIN is connected to one end of a current path in a load transistor TLM for a source follower circuit The other end of the current path in the load transistor TLM is grounded. A bias voltage VVL from the bias generation circuit 26 is applied to a gate of the load transistor TLM.

In CDS 13 and ADC 14, noise cancelling capacitances C1 and C2 are arranged for each column (vertical signal line VLIN). Moreover, a transistor TS1, a transistor TS2, and a comparator circuit COMP all required to transmit signals on the vertical signal line VLIN are arranged for each column.

The pulse signal S1 output by the timing generator 25 is supplied to a gate of transistor TS1.

Based on the signal S2, transistor TS2 inputs a reference waveform (triangular wave VREF) for analog-to-digital conversion generated by the VREF generation circuit 27, to one end of capacitance C2. The other end of capacitance C2 is connected to a connection node between transistor TS1 and capacitance C1.

The comparator circuit COMP includes an inverter INV and a transistor TS3 including a current path with its opposite ends connected between an input end and an output end of the inverter INV.

Digital signals output by the comparator circuit COMP are latched by the latch circuit 15. Thereafter, the digital signals are sequentially read by the shift register 16.

Thus, the latch circuit 15, controlled by a 10-bit counter (not shown in the drawings), outputs, for example, 10-bit digital signals OUT0 to OUT9.

In the above-described configuration, for example, it is assumed that signals are read from (n) vertical signal lines VLIN. First, the timing generator 25 sets the pulse signal ADRESn to high. This activates a source follower circuit in the read target cell 12n which includes the amplifying transistor Tb and the load transistor TLM.

Then, signal charges resulting from photoelectric conversion in the photodiode PD are accumulated for a given period.

Thereafter, before read is performed, the pulse signal RESETn is set to high to allow noise signals such as dark currents to be removed from the detector FD. Thus, the resetting transistor Tc is turned on. As a result, for example, the voltage VDD of the detector FD is set to 2.8 V.

Thus, a voltage (reset level) for which the detector FD, serving as a reference, has no signal is output to the corresponding vertical signal line VLIN.

At this time, the pulse signals S1 and S3 are set to high, and transistors TS1 and TS3 are turned on.

Thus, an analog-to-digital conversion level for the comparator circuit COMP of ADC 14 is set. Furthermore, charges the amount of which corresponds to the reset level of the vertical signal line VLIN are accumulated in capacitance C1.

Then, the pulse signal (read pulse) READn is set to high to turn on the read transistor Td. Thus, the signal charges accumulated in the photodiode PD are read into the detector FD. As a result, the voltage (signal+reset) level of the detector FD is read onto the corresponding vertical signal line “L (Low)”

At this time, the pulse signal S1 is set to high, the pulse signal S3 is set to low, and the pulse signal S2 is set to high. Then, transistor TS1 is turned on, transistor TS3 is turned off, and transistor TS2 is turned on. Charges corresponding to the “signal+reset level of the vertical signal line VLIN” are accumulated in capacitance C2.

In this case, an end of capacitance C1 through which signals are input to the inverter INV of the comparator COMP is in a high impedance state. Thus, capacitance C1 remains at the reset level.

Thereafter, the level of a reference waveform output by the VREF generation circuit is increased (the low level of the triangular wave VREF is changed to the high level). Then, the charges in capacitance C2 are subjected to analog-to-digital conversion by the comparator circuit COMP using a capacitance obtained by synthesizing capacitance C1 with capacitance C2.

For the triangular wave VREF, the analog-to-digital conversion level for 10 bits (0 to 1,023 level) is determined by the 10-bit counter.

The reset level accumulated in capacitance C1 has a polarity opposite to that of the reset level accumulated in capacitance C2. Thus, the reset level is cancelled, and the analog-to-digital conversion is performed substantially using the signal components of capacitance C2.

The analog-to-digital conversion operation for removing the reset level is called a noise reduction processing operation (correlated double sampling [CDS] operation).

To allow the analog-to-digital conversion operation to be performed once during one horizontal scan period, the VREF generation circuit 27 generates and supplies a triangular wave VREF to one end of the current path in transistor TS2.

The above-described operation corresponds to the period from the photoelectric conversion for each cell 12n until digital data is obtained.

The image sensor and the control method for the image sensor according to the present embodiment function to switch between the mode which uses the white pixel signal for signal generation and the mode which avoids using the white pixel signal for signal generation. The two modes will be described below.

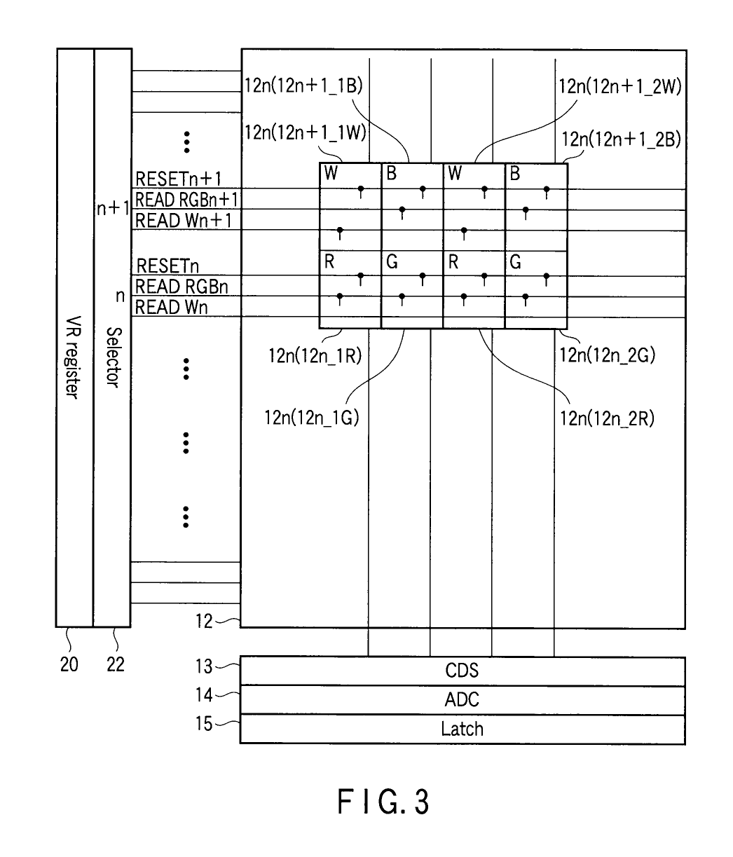

FIG. 3 shows an example of arrangement of optical color filters in the pixel unit 12, that is, an example of a configuration for implementing the above-described two modes. In this case, by way of example, one pixel block includes four pixels arranged in two rows and two columns. FIG. 3 illustrates only eight adjacent pixels (two pixel blocks) included in the above-described plurality of pixels.

That is, in the plurality of pixels 12n in the image area, four pixels 12n_W, 12n_R, 12n_G, and 12n_B arranged adjacent to one another in the row and column directions form a pixel block.

In each pixel block, for example, a white (W) pixel and a green (G) pixel are arranged on one diagonal, whereas a blue (B) pixel and a red (R) pixel are arranged on the other diagonal.

Specifically, in the present embodiment, pixels 12n_1R, 12n_1G, 12n+1₁₃1W, and 12n+1_1B form a first pixel block. Furthermore, pixels 12n_2R, 12n_2G, 12n+1_2W, and 12n+1_2B form a second pixel block located adjacent to the first pixel block.

In the pixels 12n in each pixel block, each of the W pixels 12n+1_1W and 12n+1_2W includes a white optical color filter (white filter) configured to capture incident light with a visible light wavelength.

The white filter is formed of a material that is transparent to visible light and exhibits a high sensitivity in all visible light regions (e.g. 300 nm-750 nm). Like the G pixels 12n_1G and 12n_2G, the W pixels 12n+1_1W and 12n+1_2W are suitable for acquiring luminance information.

On the other hand, each of the G pixels 12n_1G and 12n_2G includes an optical color filter (green filter) exhibiting a high transmittance for light with a green visible-light wavelength region (e.g. 490 nm-580 nm).

Each of the R pixels 12n_1R and 12n_2R includes an optical color filter (red filter) exhibiting a high transmittance for light with a red visible-light wavelength region (e.g. 580 nm-750 nm).

Each of the B pixels 12n+1_1B and 12n+1_2B includes an optical color filter (blue filter) exhibiting a high transmittance for light with a blue visible-light wavelength region (e.g. 300 nm-490 nm).

Furthermore, the present embodiment provides read pulses READ Wn+1, READ RGBn, and READ RGBn+1 serving as pulse signals READn supplied by the pulse selector circuit 22.

The read pulse READ Wn+1 is a pulse signal allowing signal charges to be read from the W pixels 12n+1_1W and 12n+1_2W. Read pulses for rows with no W pixel, such as the read pulse READ Wn, are not used.

In contrast, the read pulses READ RGBn and RGBn+1 are pulse signals allowing signal charges to be read from the R pixels 12n_1R an 12n_2R, the G pixels 12n_1G an 12n_2G, and the B pixels 12n+1_1B and 12n+1_2B.

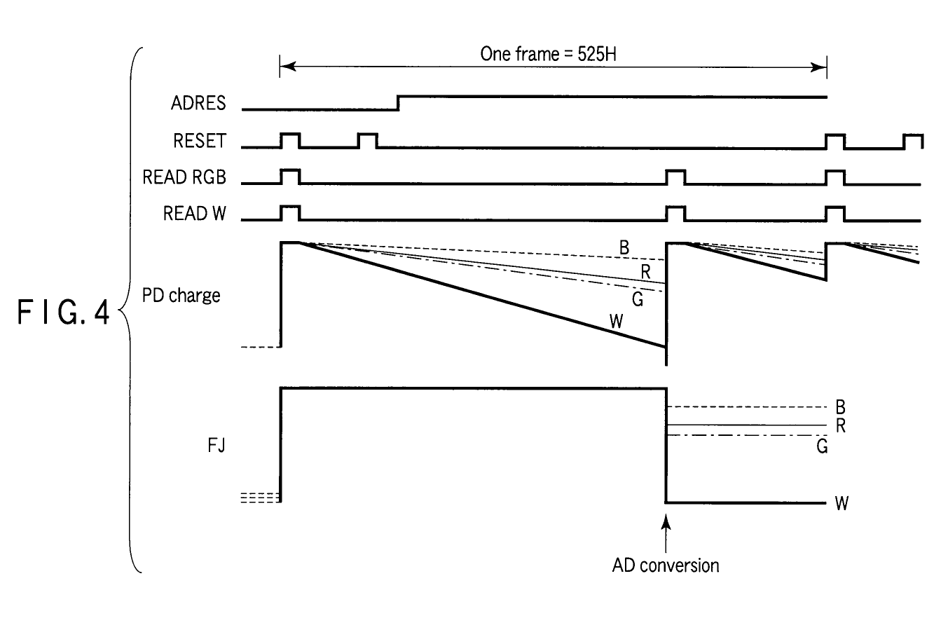

FIG. 4 is a timing chart illustrating an operation performed by the CMOS image sensor configured as described above in the mode which uses all the pixel signals including white pixel signals, for signal generation.

For example, a video graphics array (VGA) sensor is driven at 30 Hz for one frame and at a horizontal scan number of 525H. In (n) vertical lines, an accumulation time TL required to accumulate charges resulting from photoelectric conversion in the photodiode PD is 524.5H.

In synchronism with a horizontal synchronization pulse (HP), the pulse signals RESET, READ RGB, and ADRES are supplied to the red, green, and blue pixels R, G, and B in the pixel unit 12.

In synchronism with the horizontal synchronization pulse (HP), the pulse signals RESET, READ W, and ADRES are supplied to the white pixels W in the pixel unit 12.

In the present example, the pulse signals READ RGB and READ W are supplied at the same timing. That is, for the red, green, and blue pixels R, G, and B as well as the white pixels W, light is accumulated as charges during the same accumulation time TL. During the subsequent process, the intensity of light is quantified (used for signal generation). The period during which signals for one frame are read is hereinafter referred to as a vertical blanking time.

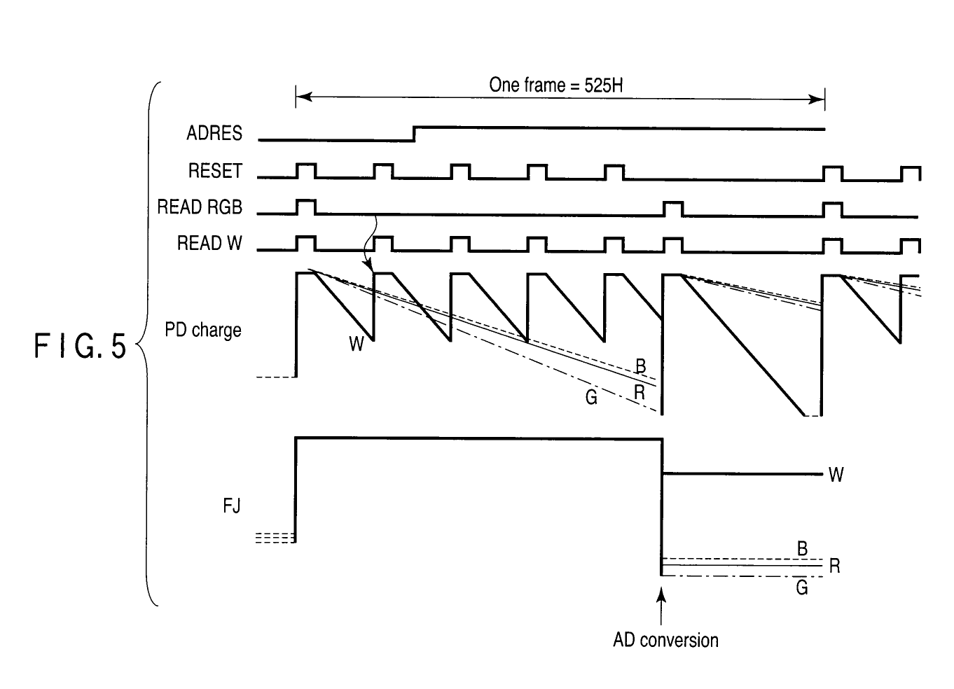

FIG. 5 is a timing chart illustrating an operation performed by the above-described VGA sensor in the mode which avoids using the white pixel signal for signal generation.

In (n) vertical lines, the pulse signals RESET, READ RGB, and ADRES are supplied to the blue, green, and blue pixels R, G, and B. This operation is the same as that in the above-described mode which uses the white pixel signal.

On the other hand, in the (n) lines in the pixel unit 12, only the pulse signals RESET and READ W are supplied to the white pixels W.

The pulse signals RESET and READ W become active a plurality of times within one frame. The activated pulse signals RESET and READ W reset the charges resulting from the photoelectric conversion in the photodiode PD to the VDD potential. Thus, only the signal charges from the red, green, and blue pixels R, G, and B are processed and quantified by the above-described scar correction circuit 35˜gamma correction circuit 41.

Upon determining that in addition to the red, green, and blue signal charges supplied by the gamma correction circuit 41, the charges from the white pixel W are close to a saturation level, the W mode selection circuit 44 executes the mode which avoids using the white pixel signal for signal generation. Thus, the dynamic range can be increased without degrading image quality.

That is, the W mode selection circuit 44 outputs a W mode selection signal indicating whether a total value for the red, green, and blue pixel signals supplied by the gamma correction circuit is equal to or lower than the saturation level or equal to or higher than the saturation level.

First, if the W mode selection signal from the W mode selection circuit 44 corresponds to a total value equal to or lower than the saturation level, the command decoder 29 outputs a switching instruction to allow the timing generator 15 and the YUV matrix circuit 42 in the main processor 31 to execute the mode which avoids using the white pixel signal for signal generation.

Then, the timing generator 15 controls the pulse selector circuit 22 and the like so as to execute a signal generation process that uses all the pixel signals including the white pixel signal. That is, the YUV matrix circuit 42 is allowed to perform an operation of generating a color difference signal YUV based on all the pixel signals generated by the scar correction circuit 32, noise reduction circuit 33, gamma correction circuit 34, the scar correction circuit 35, noise reduction circuit 36, automatic white balance (AWB) circuit 37, color mixture correction circuit 38, synchronization circuit 39, hue correction circuit 40, and gamma correction circuit 41.

On the other hand, if the W mode selection signal output by the W mode selection circuit 44 corresponds to a total value equal to or higher than the saturation level, the command decoder 29 outputs a switching instruction to allow the timing generator 15 and the YUV matrix circuit 42 in the main processor 31 to execute the mode which avoids using the white pixel signal for signal generation.

Then, the timing generator 15 controls the pulse selector circuit 22 and the like so as to execute a signal generation process that uses all the pixel signals other than the white pixel signal, that is, only the red, green, and blue pixel signals. Namely, the YUV matrix circuit 42 performs an operation of generating a color difference signal YUV based on the signals generated by the scar correction circuit 35˜gamma correction circuit 41. The YUV matrix circuit 42 avoids using the white pixel signal output by the line memory W30-2.

In the operation of generating a color difference signal YUV without using the white pixel signal, charges are reset at short time intervals, thus preventing accumulated charges for the white pixels W from being saturated, as shown in FIG. 5 described above.

However, the charges from the white pixels W are reset a large number of times during one frame (exposure) time. Thus, the accumulated charges fail to serve as a white pixel signal and also fail to serve as usable data in spite of the subsequent analog-to-digital conversion operation and the like.

As described above, the image sensor and the cool method for the image sensor according to the present embodiment allows the selective operation of the mode in which the signals for all the color pixels including the white pixel are photoelectrically converted so that the converted signals can be used for image and the mode which avoids using the white pixel signal for image.

That is, in the CMOS image sensor including white pixels in the pixel unit, if the white pixel signal is likely to be saturated, the signal generation operation is performed with charges for the white pixel signal prevented from being saturated. This enables avoidance of a phenomenon called blooming in which at a high light intensity (at a high illuminance), photoelectrons for the white pixel W are saturated to affect the adjacent red pixel R, green pixel G, and blue pixel B. Thus, the signal-to-noise ratio for the W pixel can be improved. Furthermore, with RGB pixels inhibited from being affected by blooming, the dynamic range for high-light-level image taking can be easily increased.

To prevent the photoelectrons for the W pixel from being saturated, the reset operation is intermittently performed a plurality of times during the exposure time instead of being continually performed. This enables the reset operation for the W pixel from overlapping the read operation for the R, G, and B pixels.

Furthermore, the reset operation for preventing the photoelectrons for the W pixel from being saturated is performed at a power supply voltage lower than the reset voltage for the mode which uses the white pixel signal for signal generation. Then, the power consumed for the reset operation can be reduced.

Additionally, when the mode which uses the W pixel for signal generation and the mode which avoids using the W pixel for signal generation are selectively operated, the mode is determined depending on the intensity of incident light. Then, the switching between the mode that uses the W pixel and the mode that avoids using the W pixel can be optimized.

Furthermore, during image taking (one shutter time), the mode that uses the W pixel and the mode that avoids using the W pixel are consecutively executed. Then, advantages can be taken from both the mode that uses the W pixel and the mode that avoids using the W pixel.

In the above-described embodiment, the VGA sensor is taken as an example. However, the present embodiment is not limited to this configuration but is applicable to various CMOS image sensors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid state imaging device comprising:
a pixel unit in which a plurality of pixels are two-dimensionally arranged on a semiconductor substrate, each of the pixels including
a photoelectric conversion element which converts light including white and having passed through optical color filters, into electric signal,
a read circuit which reads signal charges obtained by the photoelectric conversion element, into a detector
an amplification circuit which amplifies the signal charges, and
a reset circuit which removes unwanted signal charges from the detector;
a conversion circuit which converts the signal charge output from each of the plurality of pixels, into a digital signal; and
a mode selection circuit which,
if a level of the signal charge as the digital signal is below a saturation level,
selects a first mode which uses the signal charge from the pixel with the white optical color filter, and
if the level of the signal charge reaches the saturation level,
selects a second mode which avoids using the signal charge from the pixel with the white optical color filter.

2. The device according to claim 1, further comprising a control circuit which, if the mode selection circuit selects the second mode, resets the signal charge from the pixel with the white optical color filter.

3. The device according to claim 2, wherein the control circuit intermittently operates the read circuit during an exposure time so as to prevent the signal charge read from the pixel with the white optical color filter being saturated.

4. The device according to claim 2, wherein in the first mode which uses the signal charge from the pixel with the white optical color filter for image, the control circuit operates the read circuit at a power supply voltage lower than a reset voltage for the reset circuit.

5. The device according to claim 3, wherein in the first mode which uses the signal charge from the pixel with the white optical color filter for image, the control circuit operates the read circuit at a power supply voltage lower than a reset voltage for the reset circuit.

6. The device according to claim 1, further comprising a control circuit which, if the mode selection circuit selects the second mode, resets the signal charge from the pixel with the white optical color filter,
wherein depending on the intensity of incident light, the mode selection circuit selects the first mode which uses the signal charge from the pixel with the white optical color filter for image or the second mode which avoids using the signal charge from the pixel with the white optical color filter for image.

7. The device according to claim 6, wherein the optical color filter includes filters which passes, in addition to the white light, red light, green light, and blue light, respectively, and arranged for the respective pixels, and
if the first mode is selected by the mode selection circuit,
the control circuit synchronizes a timing when the signal charges having passed through the filters for the red light, green light, and blue light and thus been photoelectrically converted in the photoelectric conversion unit are read into the detector and a timing when the signal charge having passed through the filter for the white light and thus been photoelectrically converted in the photoelectric conversion unit is read into the detector.

8. The device according to claim 6, wherein the optical color filter includes filters which pass, in addition to the white light, red light, green light, and blue light, respectively, and arranged for the respective pixels, and
if the second mode is selected by the mode selection circuit,
the control circuit intermittently reads the signal charge having passed through the filter for the white light and thus been photoelectrically converted in the photoelectric conversion portion, into the detector.

9. The device according to claim 1, wherein the mode selection circuit consecutively selects, during one image operation,
the mode which uses the signal charge from the pixel with the white optical color filter for image and
the mode which avoids using the signal charge from the pixel with the white optical color filter for image.

10. The device according to claim 1, wherein the optical color filters includes filters which passes the white light, red light, green light, and blue light and arranged on the respective plurality of pixels, and
the photoelectric conversion elements generate electrons for the white light, red light, green light, and blue light, respectively, from one pixel block.

11. A solid state imaging device comprising:
a pixel unit in which a plurality of pixels are arranged in a matrix, each of the pixels including
a color filter in which filters pass white light, red light, green light, and blue light, respectively, are two-dimensionally arranged,
a photoelectric conversion element which converts the light having passed through the color filter, into electric signal, and
a read circuit which reads signal charges obtained by the photoelectric conversion unit;
a conversion circuit which digitally converts the signal charges read from the plurality of pixels;
a selection circuit which generates a selection signal indicating whether or not to use the signal charge read from a pixel with the filter which passes the white light, depending on a total value for the digitally converted signal charges for the red light, the green light, and the blue light; and
a controller which controls whether or not to use the signal charge read from the pixel with the filter which passes the white light, depending on the selection signal from the selection circuit.

12. The device according to claim 11, wherein the controller, if the total value is equal to or greater than a specified value level, controls the pixel unit so as to avoid using the signal charge read from the pixel with the filter which passes the white light.

13. The device according to claim 11, wherein the controller reads the signal charge from the pixel with the filter which passes the white light, from the read circuit a plurality of times during one vertical blanking time so as to prevent saturation of the signal charge read from the pixel with the filter which passes the white light.

14. The device according to claim 11, wherein if the total value is equal to or lower than a specified value level,
the controller controls the pixel unit so as to use the signal charge read from the pixel with the filter which passes the white light.

15. The device according to claim 11, wherein the optical color filters includes filters which passes the white light, red light, green light, and blue light and arranged on the respective plurality of pixels, and
the photoelectric conversion elements generate electrons for the white light, red light, green light, and blue light, respectively, from one pixel block.

16. The device according to claim 11, wherein the selection circuit consecutively executes, during the one vertical blanking time, the use of the signal charge read from the pixel with the filter which passes the white light and the avoidance of the use of the signal charge read from the pixel with the filter which passes the white light.

17. The device according to claim 14, wherein the controller synchronizes a timing when the signal charges having passed through the filters for the red light, green light, and blue light and thus been photoelectrically converted in the photoelectric conversion unit are read into the detector, with a timing when the signal charge having passed through the filter for the white light and thus been photoelectrically converted in the photoelectric conversion unit is read into the detector.

18. A solid state imaging device comprising:
a selection circuit which generates a selection signal indicating whether or not to use a signal charge read from a pixel which charges a signal for the white light, depending on a total value of signal charges for a red light, a green light, and a blue light, the signal charges for the red light, the green light, and the blue light being read from a plurality of pixels and being converted into digital signal.

19. The device according to claim 18, wherein depending on the intensity of the red light, the green light, and the blue light, the selection circuit selects the first mode which uses the signal charge from the pixel with the white optical color filter for image or the second mode which avoids using the signal charge from the pixel with the white optical color filter for image.

20. The device according to claim 18, further comprising a controller,
the controller which controls whether or not to use the signal charge read from the pixel with a filter which passes the white light, depending on the selection signal from the selection circuit.
